(19) United States
(12) Patent Application Publication
(10) Pub. No.: US 2012/0163974 A1
(43) Pub. Date: Jun. 28, 2012

(54) USE OF AUTOMATION IN WIND DATA ACQUISITION SYSTEMS TO IMPROVE WIND RESOURCE ASSESSMENT ACCURACY

(76) Inventors: Brendan F. Taylor, South Burlington, VT (US); Wyatt Drake-Buhr, Williston, VT (US); J. Carl Irving, Burlington, VT (US); Dale E. Williams, Vergennes, VT (US); Robert H. Macklin, Jericho, VT (US); Guy S. Kirchhoff, North Hero, VT (US)

(21) Appl. No.: 13/246,804

(22) Filed: Sep. 27, 2011

Related U.S. Application Data
(60) Provisional application No. 61/386,950, filed on Sep. 27, 2010.

(51) Int. Cl. F03D 11/00; F03D 1/00

(52) U.S. Cl. 416/61

(57) ABSTRACT

Generally, a wind data acquisition system configured to perform wind resource assessments. A system consistent with the present disclosure may provide a cost-effective data acquisition and analysis system useful for performing wind resource assessments. The system may be configured to automatically detect heights and bearings of instrument mounting booms associated with a wind tower. The system may further be configured to improve the accuracy of differential temperature measurements of a wind tower by providing automatic calibration of components used to measure differential temperature.

### CROSS REFERENCE TO RELATED APPLICATIONS

This application claims the benefit of U.S. provisional patent application Ser. No. 61/386,950, filed Sep. 27, 2010, the entire disclosure of which is incorporated herein by reference.

### TECHNICAL FIELD

The present disclosure relates to wind resource assessment systems, and, in particular, the use of automation in wind data acquisition systems to improve wind resource assessment accuracy.

### BACKGROUND

Wind resource assessment may generally be understood to be the process by which wind power developers, for example, estimate the future energy production of a wind farm. The successful development of a wind farm may depend on accurate wind resource assessments. In order to estimate the energy production of a wind farm, developers may first measure the wind on site. Wind towers may be equipped with a variety of components that may aid wind resource assessment, including, but not limited to, anemometers, wind-direction vanes, and temperature, pressure, and relative humidity sensors.

When performing wind resource assessments, a variety of calculations may be necessary to accurately estimate the energy production of the potential wind farm. For example, when deploying equipment for performing a wind resource assessment, it may be useful to record data pertaining to instrument mounting booms, including the height and bearing of the instrument booms. One known approach is to collect the height and bearing of instrument booms via manual measurement, such as using a tape measure and a compass or GPS. This method of measurement, however, may lead to incorrect recordation of data, which may further lead to inaccurate results and reduced certainty of the wind assessment. In addition, further site visit for additional measurements may be required, ultimately leading to an increase in the cost of performing the wind resource assessment.

Additionally, when performing a wind resource assessment, it may be necessary to determine the wind speed at a height above the top of a wind tower using extrapolation. In order to determine a wind speed using extrapolation, it may be necessary to determine the wind shear coefficient, which is affected by the atmospheric stability. It has been shown that an accurate differential temperature measurement (from top to bottom of tower) can be used to estimate the atmospheric stability, and therefore the wind shear coefficient.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a functional block diagram of an exemplary wind acquisition system consistent with the present disclosure;

FIG. 2 is a top view of a wind tower of a system consistent with the present disclosure; and

FIG. 3 is a front view of the wind tower of FIG. 2 with an instrument boom attached thereto.

### DETAILED DESCRIPTION

The present disclosure is generally directed to wind data acquisition systems. Embodiments described herein may relate to a wind data acquisition system configured to perform wind resource assessments. Generally, a system and method consistent with the present disclosure may provide a cost-effective data acquisition and analysis system useful for performing wind resource assessments. The system may be configured to collect data from a plurality of components and to determine a variety of measurements related to wind resource assessment based on collected data. In particular, the system may be configured to automatically detect heights and bearings of instrument mounting booms associated with a wind tower. The system may further be configured to improve the accuracy of differential temperature measurements of a wind tower by providing automatic calibration of components used to measure differential temperature. A system and method consistent with the present disclosure may therefore provide accurate and reliable data collection and calculation, thereby improving certainty of the wind resource assessment.

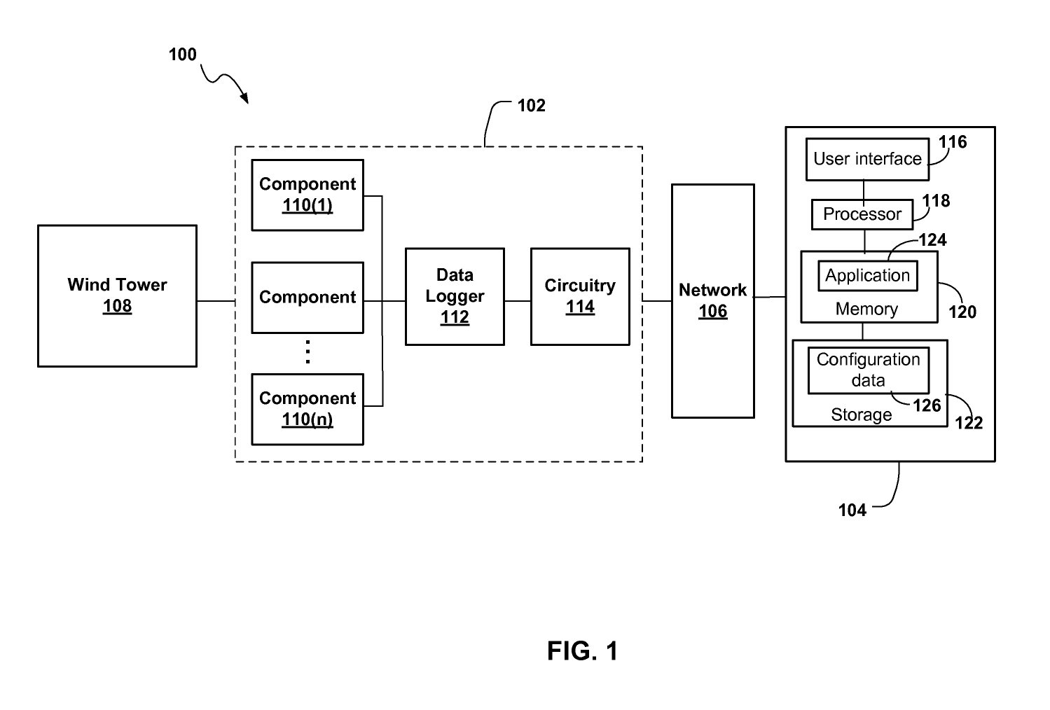

Turning to FIG. 1, a wind acquisition system 100 consistent with the present disclosure may include a data acquisition subsystem 102 coupled to a base station 104. The subsystem 102 may be coupled to the base station 104 via a network 106 that may include wired and/or wireless links. For example, the network 106 may utilize an Ethernet protocol. The Ethernet protocol may comply or be compatible with the Ethernet standard published by the Institute of Electrical and Electronics Engineers (IEEE) titled “IEEE 802.3 Standard”, published in March, 2002 and/or later versions of this standard. The base station 104 may be located a distance from the tower site, e.g., in a controlled environment.

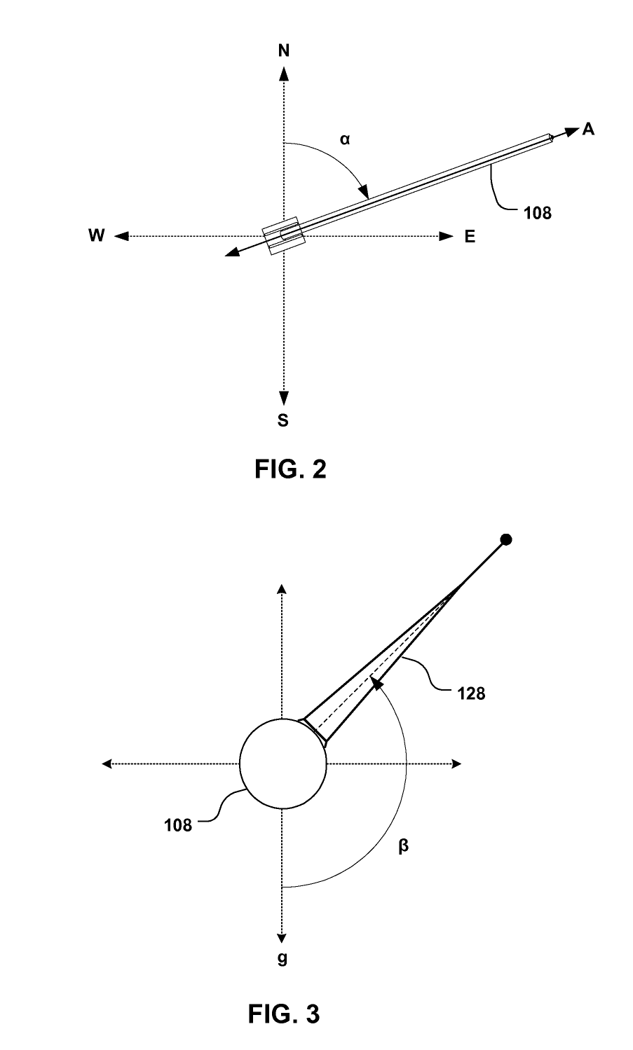

The data acquisition subsystem 102 may be associated with a wind tower 108 and may be located at a tower site, relatively near the tower 108 being monitored. The data acquisition subsystem 102 may include one or more components 110(1), . . . , 110(n) (generically component 110) coupled to a portion of the tower 108. For example, in one embodiment, each component 110 may be mounted to a portion of the tower 108 via an instrument boom (shown in FIG. 2B). In addition, or alternatively, each component 110 may be mounted within remote bus extenders (hereinafter referred to as “pods”). The components 110 may include instruments and/or sensors configured to detect a parameter associated with the tower 108 being monitored and to provide as output sensor data corresponding to the parameter. Components 110 may include, but are not limited to, accelerometers, anemometers, wind vanes, tachometers, barometric pressure sensors, temperature sensors, acoustic sensors, global positioning system (GPS) units and/or other instruments and/or sensors known to those skilled in the art. It should be noted that a system consistent with the present disclosure may include a plurality of data acquisition subsystems, each of the subsystems being associated with a respective wind tower at a tower site, wherein wind resource assessment measurements of each of the respective wind towers may be determined, thereby allowing a user to determine an overall wind resource assessment of a potential wind farm site.

The data acquisition subsystem 102 may further include a data logger 112 coupled to each of the components 110(1), . . . 110(n), and configured to collect and store output sensor data from each of the components 110(1), . . . , 110(n). A data logger 112 consistent with the present disclosure may collect data from each of the components 110 over a specific period of time and/or in relation to specific location. Additionally, in addition to be configured to collect data from external components, a data logger 112 consistent with the present disclosure may collect data from built-in or internal components, such a GPS instrument.

The data logger 112 may be coupled to and configured to transmit collected output sensor data to circuitry 114. The circuitry 114 may be configured to analyze the received output sensor data and to generate measurements related to wind resource assessment based on the output sensor data. For example, the circuitry 114 may include custom, proprietary, known and/or after-developed code (or instruction sets), hardware, and/or firmware that are generally well-defined and operable to receive output sensor data and calculate measurements related to wind resource assessment. The circuitry 114 may be coupled to and configured to communicate with the base station 104 via the network 106. The circuitry 114 may be further configured to provide calculated measurements to the base station 104.

The base station 104 may include a user interface 116, a processor 118, memory 120 and/or storage 122. The base station 104 is configured to communicate with the data acquisition subsystem 102 over the network 106. In particular, the base station 104 may be configured to provide updates to the circuitry 114 concerning code, hardware, and/or firmware for calculating measurements. The base station 104 may be configured to provide a user access to the subsystem 102. For example, the base station 102 may be configured to display data and/or information related to output sensor data of each of the components 110 and or measurements generated by the circuitry 114 using user interface 116. The base station 102 may be configured to provide an measurements related to wind resource assessment, as described herein.

The user interface 116 may include a graphical user interface (GUI) configured to facilitate access to the data and/or information. The GUI may be configured to provide graphical illustrations of acquired data and/or analysis results to a user. The memory 120 may be configured to store and the processor 118 may be configured to run an application program 124 configured for acquiring, analyzing and/or displaying sensor status data. The memory 120 and/or storage 122 may be configured to store configuration data 126, sensor data and/or machine and/or equipment-related data, as described herein.

In one embodiment, a system 100 consistent with the present disclosure may be configured to automatically determine, for example, a height and bearing of an instrument mounting boom 128 (shown in FIG. 3) and to embed such information into a wind data stream deliverable to end users, thereby reducing chance of error, ultimately resulting in cost reduction. By way of an overview, the system may automatically detect boom height from the ground and boom bearing relative to true north. This may involve use of GPS measurements from multiple components, accelerometer measurements from an anemometer and/or wind vane, and user action at the data logger 112. It should be noted that the system allows a user to over-ride automatic measurements of data with manual measurements in cases where measurement is uncertain or the tower is not a tilt-up type.

For example, as shown in FIGS. 2 and 3, a system consistent with the present disclosure may include a tilt-up wind tower 108 as shown. In the event that the system 100 includes a tilt-up tower 108, the data acquisition subsystem 102 includes components 110 configured to detect parameters associated with the calculation of height and bearing of an object, such as the mounting boom. In particular, the data acquisition subsystem 102 may include at least a GPS instrument, a barometric pressure sensor, and an accelerometer mounted to the tower 108. In one embodiment, the at least one component 110 may be mounted on a pod, wherein the pod is mounted to the instrument boom. In other embodiments, multiple components 110 may be mounted on a single pod and the system may include multiple pods.

In the event that the components 110 are mounted in pods, the pod height may be calculated by taking a barometric pressure (BP) measurement from the barometric pressure sensor when the pod is on the ground, and again when the pod is in the air. The output sensor data from the BP sensor may then collected by the data logger 112 and further transmitted to the circuitry 114. The circuitry 114 may then calculate the pod height based on any change in pressure. The equation for this calculation is: h=hₒ In (P/Pₒ), where h is the calculated height, hₒ is the constant scale height (7000 millibars), P is the measured pressure in millibars and Pₒ is the pressure at h=0 (ground level).

The selected BP sensor may be temperature-compensated and therefore highly accurate (0.1 millibar resolution translates to +/−0.7 m accuracy). In order to obtain the high accuracy, it is important that the measurement be taken by the same sensor both on the ground and when the tower is tilted up (i.e. the sensor has good relative accuracy, but there is too much variation in absolute accuracy from sensor to sensor). Additionally, in a preferred embodiment, the pod is installed in such a manner that a top edge of the pod is aligned with a bottom edge of the instrument boom so that there is a known distance between the pod and either sensor on the boom (anemometer on top, vane on bottom).

For each sensor detected on the pod, the appropriate amount of offset is added to the pod height by default so that it automatically estimates and records the height for each sensor. Again, the user will be able to manually over-ride this estimation.

In the event where the barometric pressure changes during the tilt-up time due to environmental conditions, such as weather, it is necessary to compensate the pressure change measurements taken by each pod. In order to compensate for change in conditions, a BP sensor may be installed in the data logger 112, the BP sensor likely remaining at or near the same height throughout the tilt-up process. Thus, any change in pressure identified by the data logger 112 may be subtracted from the change in pressure detected by the pods.

As previously discussed, a system consistent with the present disclosure is configured to automatically detect boom bearing, in addition to boom height. By knowing the bearing of the tower 108 when tilted down (shown in FIG. 2) and the angle of the boom 128 relative to gravity (shown in FIG. 3), the bearing of the boom when the tower is tilted up may be calculated. In reference to FIGS. 2 and 3, α represents the bearing of the tower when in a tilted down position, and β represents the angle of the boom 128 relative to gravity (g). The equation for the calculation of the boom bearing, θ, is: θ=(α+β)mod 2π.

The tower bearing α may calculated by collecting GPS measurements in at least two locations along the axis A of the tower 108, then using the known formula, such as the Haversine formula for example, to calculate the bearing α. In one embodiment, there may be a GPS instrument in the data logger 112 as well as each pod, thereby allowing multiple methods to calculate the tower bearing. As generally understood, accuracy improves as distances between two GPS measurements increases along the axis A. Reasonable accuracy can be obtained when the measurements are taken by a pod located at the top of the tower and a data logger at the base of the tower. Accuracy may be improved when a user moves the data logger 112 a given distance (e.g. 100 m) from the base of the tower, aligned with the tower axis A, and takes the measurement there.

In one configuration the user may initiate a Tilt-Up Mode on the data logger 112 via a user interface on the data logger 112. This may cause the data logger 112 and all pods to perform a time sync, then initiates each pod taking and storing BP, accelerometer, and GPS data (including information about the number of satellites used for the measurement) for a specified period of time (e.g. every one minute) until the Tilt-Up Mode is exited, or the mode times out (e.g. two hours). When the mode is exited at the data logger 112, the data logger 112 may be configured to query each pod for the one-minute data. The data may then be analyzed by the circuitry 114 and calculate the pod height, sensor height, and boom bearing. The user may then be presented with this information at the user interface of the data logger 112, allowing a user to check and optionally over-ride the values.

In the event that the system includes a non-tilt-up tower, there may still a convenient and accurate way to manually record measurements pertaining to the boom bearing. This may also be desirable for some users who aren't confident in the automatic boom bearing detection, or think they may have inaccuracy due to circumstances beyond their control (e.g. severe tower bend while laying on the ground due to complex terrain). To manually measure the boom bearing, a user may mark a GPS way point at the base of the tower using the data logger. The user may then travel some distance (e.g. 100 m) away from the tower and align themselves with the boom they are measuring with the Logger in their hand. The user may then mark another waypoint. With these two waypoints, the boom bearing may be calculated with great accuracy. As such, the farther the distance traveled by the user, the more accurate the manual measurement.

In one embodiment, a system 100 consistent with the present disclosure may be configured to determine differential temperature measurement via automatic calibration of sensors coupled to the tower. In particular, temperature sensors and barometric pressure sensors may be mounted at the top and bottom of a tilt-up tower. Prior to tilting the tower in an up position, the sensors are automatically calibrated relative to one another, thereby improving accuracy of the differential temperature measurement and improving the estimation of atmospheric stability and wind shear coefficient.

According to one aspect, there is provided a wind farm site. The wind farm site may include a plurality of wind towers and a plurality of data acquisition systems, each of the plurality of data acquisition systems being coupled to a separate associated one of the plurality of wind towers. Each data acquisition system may include a plurality of sensors, each of the plurality of sensors may be coupled to a respective portion of a wind tower and configured to detect a parameter associated with the respective portion of the wind tower and to provide sensor data based at least in part on the parameter. Each data acquisition system may further include a data logger coupled to each of the plurality of sensors and configured to receive sensor data from each of the plurality of sensors and store the sensor data. Additionally, circuitry may be coupled to the data logger and configured to receive sensor data from the data logger, to analyze the sensor data, and to generate output data comprising representations of wind resource assessment measurements associated with the wind tower. The circuitry may be configured to provide output data to a base station, wherein the base station may be configured to provide wind resource assessments of the wind tower to a user based at least in part on the output data received from the circuitry.

According to another aspect there is provided a data acquisition system for use in wind resource assessment. The data acquisition system may include a plurality of sensors, each of the plurality of sensors may be coupled to a respective portion of a wind tower and configured to detect a parameter associated with the respective portion of the wind tower and to provide sensor data based at least in part on the parameter. Each data acquisition system may further include a data logger coupled to each of the plurality of sensors and configured to receive sensor data from each of the plurality of sensors and store the sensor data. Additionally, circuitry may be coupled to the data logger and configured to receive sensor data from the data logger, to analyze the sensor data, and to generate output data comprising representations of wind resource assessment measurements associated with the wind tower. The circuitry may be configured to provide output data to a base station, wherein the base station may be configured to provide wind resource assessments of the wind tower to a user based at least in part on the output data received from the circuitry.

According to another aspect, there is provided a method of generating a wind resource assessment of a potential wind farm site. The method may include providing a plurality of data acquisition systems, each of the plurality of data acquisition systems being coupled to a separate associated one of a plurality of wind towers. Each data acquisition system may include a plurality of sensors, each of the plurality of sensors being coupled to a respective portion of a wind tower and a data logger coupled to each of the plurality of sensors and configured to receive sensor data from each of the plurality of sensors and store the sensor data. The method may further include detecting a parameter associated with a selected one of the respective portions of the wind tower using an associated one of the plurality of sensors and providing sensor data from the associated one of the plurality of sensors to the data logger based at least in part on the parameter. The method may further include providing the sensor data to circuitry and analyzing the sensor data via the circuitry, and generating output data based at least in part on the sensor data, the output data comprising representations of wind resource assessment measurements associated with the wind tower. Additionally, the method may include providing the output data to a base station and providing wind resource assessments of the wind tower to a user based at least in part on the output data received from the circuitry.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Embodiments of the methods described herein may be implemented using a processor and/or other programmable device. To that end, the methods described herein may be implemented on a tangible computer readable medium having instructions stored thereon that when executed by one or more processors perform the methods. Thus, for example, controller 118 may include a storage medium (not shown) to store instructions (in, for example, firmware or software) to perform the operations described herein. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

What is claimed is:

1. A wind farm site comprising:
a plurality of wind towers; and
a plurality of data acquisition systems, each of said plurality of data acquisition systems being coupled to a separate associated one of said plurality of wind towers, each data acquisition system comprising:
a plurality of sensors, each of said plurality of sensors being coupled to a respective portion of a wind tower and configured to detect a parameter associated with said respective portion of said wind tower and to provide sensor data based at least in part on the parameter;
a data logger coupled to each of said plurality of sensors and configured to receive sensor data from each of said plurality of sensors and store said sensor data; and
circuitry coupled to said data logger and configured to receive sensor data from said data logger, to analyze said sensor data, and to generate output data comprising representations of wind resource assessment measurements associated with said wind tower, said circuitry configured to provide output data to a base station;
wherein said base station is configured to provide wind resource assessments of said wind tower to a user based at least in part on the output data received from said circuitry.

2. The wind farm site of claim 1 wherein one of said plurality of sensors is a global positioning satellite (GPS) unit configured to detect a location of a respective portion of said wind tower.

3. The wind farm site of claim 1 wherein one of said plurality of sensors is a accelerometer configured to detect a wind speed at or near a respective portion of said wind tower.

4. The wind farm site of claim 1 wherein one of said plurality of sensors is a barometric pressure sensor configured to detect a barometric pressure at or near a respective portion of said wind tower.

5. The wind farm site of claim 1 wherein said wind resource assessment measurements comprise a height and a bearing of an instrument mounting boom of said wind tower.

6. The wind farm site of claim 1 wherein said wind resource assessment measurements comprise a differential temperature from a top of said wind tower to a bottom of said wind tower.

7. The wind farm site of claim 1 wherein said wind tower is a tilt-up tower.

8. A data acquisition system for use in wind resource assessment, said data acquisition system comprising:
a plurality of sensors, each of said plurality of sensors being coupled to a respective portion of a wind tower and configured to detect a parameter associated with said respective portion of said wind tower and to provide sensor data based at least in part on the parameter;
a data logger coupled to each of said plurality of sensors and configured to receive sensor data from each of said plurality of sensors and store said sensor data; and
circuitry coupled to said data logger and configured to receive sensor data from said data logger, to analyze said sensor data, and to generate output data comprising representations of wind resource assessment measurements associated with said wind tower, said circuitry configured to provide output data to a base station;
wherein said base station is configured to provide wind resource assessments of said wind tower to a user based at least in part on the output data received from said circuitry.

9. The system of claim 8 wherein one of said plurality of sensors is a global positioning satellite (GPS) unit configured to detect a location of a respective portion of said wind tower.

10. The system of claim 8 wherein one of said plurality of sensors is a accelerometer configured to detect a wind speed at or near a respective portion of said wind tower.

11. The system of claim 8 wherein one of said plurality of sensors is a barometric pressure sensor configured to detect a barometric pressure at or near a respective portion of said wind tower.

12. The system of claim 8 wherein said wind resource assessment measurements comprise a height and a bearing of an instrument mounting boom of said wind tower.

13. The system of claim 8 wherein said wind resource assessment measurements comprise a differential temperature from a top of said wind tower to a bottom of said wind tower.

14. The system of claim 8 wherein said wind tower is a tilt-up tower.

15. A method of generating a wind resource assessment of a potential wind farm site, said method comprising:
a plurality of data acquisition systems, each of said plurality of data acquisition systems being coupled to a separate associated one of a plurality of wind towers, each data acquisition system comprising:
a plurality of sensors, each of said plurality of sensors being coupled to a respective portion of a wind tower; and
a data logger coupled to each of said plurality of sensors and configured to receive sensor data from each of said plurality of sensors and store said sensor data;
detecting a parameter associated with a selected one of said respective portions of said wind tower using an associated one of said plurality of sensors and providing sensor data from said associated one of said plurality of sensors to said data logger based at least in part on the parameter;
providing said sensor data to circuitry and analyzing said sensor data via said circuitry;
generating output data based at least in part on said sensor data, said output data comprising representations of wind resource assessment measurements associated with said wind tower;
providing said output data to a base station; and
providing wind resource assessments of said wind tower to a user based at least in part on the output data received from said circuitry.

16. The method of claim 15 wherein said wind resource assessment measurements comprise a height and a bearing of an instrument mounting boom of said wind tower.

17. The method of claim 15 wherein said wind resource assessment measurements comprise a differential temperature from a top of said wind tower to a bottom of said wind tower.

18. The method of claim 15 wherein one of said plurality of sensors is a accelerometer configured to detect a wind speed at or near a respective portion of said wind tower and another one of said plurality of sensors is a barometric pressure sensor configured to detect a barometric pressure at or near a respective portion of said wind tower.

19. The method of claim 15 wherein one of said plurality of sensors is a global positioning satellite (GPS) unit configured to detect a location of a respective portion of said wind tower.

20. The method of claim 15 wherein said wind tower is a tilt-up tower.
